(19) United States
(12) Patent Application Publication
(10) Pub. No.: US 2001/0051988 A1
(43) Pub. Date: Dec. 13, 2001

(54) Methods for forwarding hybrid mail

(76) Inventor: Hoon Dong Kim, Seoul (KR)

Correspondence Address: HARTER SECREST & EMERY, LLP, 1600 BAUSCH & LOMB PLACE, ROCHESTER, NY, 14604-2711, US

(21) Appl. No.: 09/799,234

(22) Filed: Mar. 5, 2001

(30) Foreign Application Priority Data
Mar. 6, 2000 (KR) 2000-11123

(51) Int. Cl. G06F 15/16

(52) U.S. Cl. 709/206

(57) ABSTRACT

The present invention relates to the method for forwarding hybrid mail and, more particularly, makes it possible that the status of the branch closest to the recipient's address may be recognized real time through coordination of the central management server and the branch management servers.

The central management server may easily obtain information such as “when the sender's e-mail may be delivered at the recipient” and “the current delivery status of the paper mail” and, resultantly, the central management server may expeditiously notify the sender of the estimate delivery period for the paper mail and the receipt status of the paper mail, etc. Therefore, a sender using the present invention may experience a highly improved efficiency in using the hybrid mail system.

### BACKGROUND OF THE INVENTION

1. Field of the Invention

The present invention relates to the method for forwarding hybrid mail. More particularly, the present invention relates to the method for forwarding hybrid mail, by which a sender may obtain real time information regarding the mail piece, such as the estimate delivery period, receipt status, etc.

2. Description of the Related Art

The traditional paper mail system is inconvenient because a sender must personally have his or her mail pieces put into the delivery system. Moreover, in the traditional paper mail system, if a recipient is located significantly distant from a sender, a great amount of time and expense is required. Moreover, it is very difficult to confirm that the mail piece has been delivered.

As the Internet is widely used these days, e-mail has become very popular. The e-mail system has resolved some of the disadvantages of the paper mail system such as the time and expense required for conventional mail system. However, the email system itself contains various problems.

Thus, recently, as a way to overcome shortcomings of the paper mail system and the e-mail system, a new mail system called “hybrid mail” has been introduced.

A sender using the conventional hybrid mail system may conveniently send a paper mail piece quickly to a recipient merely through a simple e-mail transmission.

Generally, such hybrid mail service is performed by a hybrid mail system comprised of a central management server and branch management servers. In such hybrid mail system, the central management server transmits e-mail sent from a sender to a branch management server. The branch management server prints out the e-mail sent from the central management server.

In the conventional hybrid mail system, however, the said central management server performs only the process of transmitting the user's e-mail to a branch management server and does not monitor branch management servers. Thus, the central management server may not obtain current and exact information on branch management servers and, therefore, may not provide senders with various valuable information.

For example, if the central management server is able to have information regarding a branch management server, such as information of “when the recipient will be able to receive the sender's mail,” the central management server can notify the sender of the estimate delivery period quickly based upon such information. However, as in the conventional hybrid mail system, if the central management server cannot obtain exact information of branch management servers' status, the central management server cannot provide such valuable information to senders.

Also, if the central management server is to obtain information regarding a branch management server, such as information of “where the paper mail piece is at the present time,” the central management server can notify the sender of the current receipt status of the paper mail quickly based upon such information. However, as in the conventional hybrid mail system, if the central management server cannot obtain exact information of branch management servers' status, the central management server cannot provide such information to senders at all.

Therefore, the present invention's objective is to enable the central management server to provide senders with information, such as “estimate delivery period” and “paper mail's receipt status,” expeditiously by implementing the mail system in which the central management server monitors real time the status of branch management servers.

Another objective of the present invention is to enable a sender to have exact information regarding “estimate delivery period” before the sender transmits any e-mail and, thus, to cause the sender to select the most appropriate method of mail delivery among various delivery methods such as ordinary mail and registered mail, etc.

Another objective of the present invention is to enable a sender to be informed of “receipt status of the paper mail” after the transmission of e-mail and, thus, to maximize the efficiency in sender's use of the mail service.

Other objectives of the present invention will be apparent in the following detailed explanations and references made to the attached drawings.

### SUMMARY OF THE INVENTION

In order to attain the objectives, the present invention performs the steps of: transmitting a page for basic mail information input to a sender side client in a hardware environment where the sender side client, the central management server and multiple branch management servers are connected for telecommunication; determining whether the basic mail information input procedure using the said transmitted page for the basic mail information input has been completed; searching for a branch which is closest to the recipient's address based upon the said basic mail information; calculating the estimate delivery period of a paper mail piece by extracting real time the current status of the said closest branch; and transmitting to the sender side client the message containing the estimate delivery period for the paper mail piece.

The present invention further comprises the steps of: determining whether receipt confirmation events have occurred from the said sender side client to confirm the receipt of the paper mail piece; if receipt confirmation events have occurred from the said sender side client, extracting sender information from the basic mail information while selecting the closest branch corresponding to the sender information and extracting real time the selected closest branch's status; confirming the receipt of the paper mail piece based upon the closest branch's status; and outputting consequence data reflecting the result of the paper mail receipt confirmation and transmitting the said consequence data to the said sender side client.

According to the present invention, the status of the closest branch may be notified real time through the coordinated operations of the central management server and branch management servers. Thus, information such as “when the sender's e-mail will be received by the recipient” and “where the paper mail piece is in the delivery process at the present time” may be easily obtained. Consequently, the central management server may expeditiously notify the sender of information such as the estimate delivery period of the paper mail piece or the receipt status of the paper mail piece. Therefore, the sender using the present invention may experience the highly improved efficiency in using the comprehensive hybrid mail system.

### BRIEF DESCRIPTION OF THE DRAWINGS

FIG. 1 is a diagram illustrating a hybrid mail transmission system to implement the hybrid mail forwarding method according to the present invention.

FIG. 2 is a flow diagram illustrating the method for forwarding hybrid mail according to the present invention's preferred implementation.

FIG. 3 to FIG. 5 are diagrams showing the web pages displayed to the sender side client according to the present invention's preferred implementation.

FIG. 6 and FIG. 7 are diagrams illustrating data stored in the central management database according to the present invention's preferred implementation.

FIG. 8 is a diagram showing the web page displayed to the sender side client according to the present invention's preferred implementation.

FIG. 9 and FIG. 10 are flow diagrams showing the sequence of the hybrid mail forward method according to the present invention's preferred implementation.

FIG. 11 and FIG. 12 are diagrams illustrating data stored in the central management database according to the present invention's preferred implementation.

### DETAILED DESCRIPTION OF THE PREFERRED EMBODIMENTS

Reference will now be made in detail to the method for forwarding hybrid mail according to the present invention's preferred implementation as illustrated in the accompanying drawings.

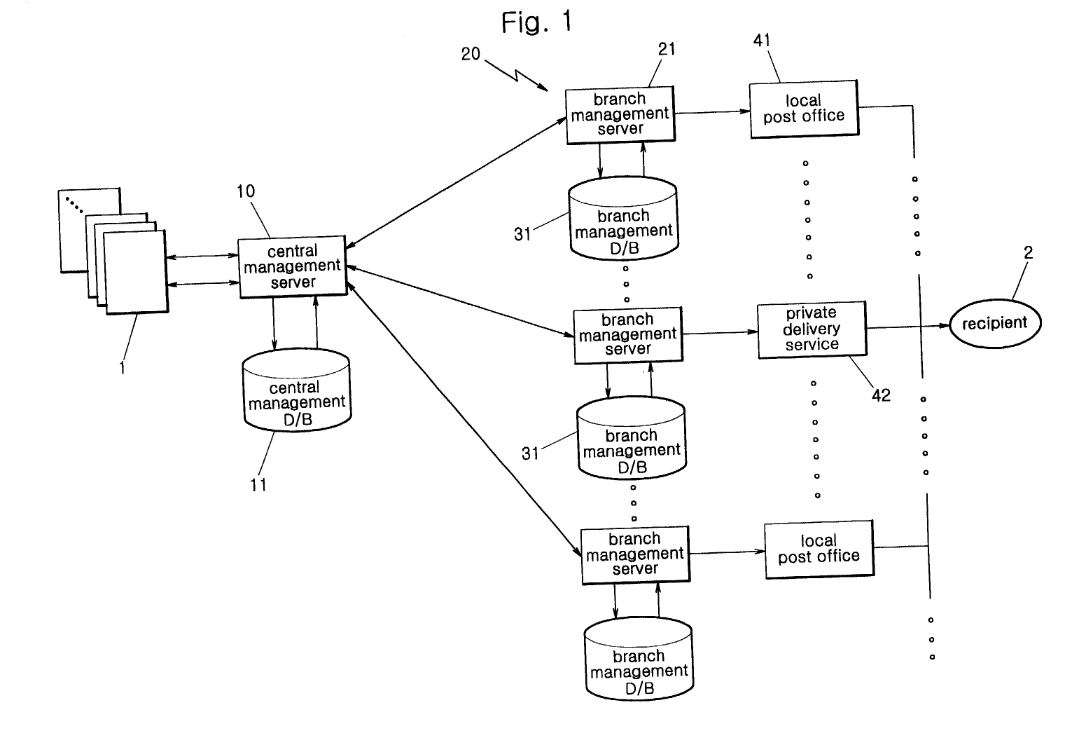

As illustrated in FIG. 1, the hybrid mail transmission system for implementing the present invention's method for forwarding hybrid mail is comprised primarily of a central management server (10) and branch management servers (20).

The central management server (10) is connected to a sender side client (1) through the Internet and if a sender using the said sender side client (1) transmits an email message, the said central management server (10) transmits the said e-mail message to a branch management server (20). The said branch management server prints out the said sender's e-mail and produces a paper mail piece. The said printed paper mail piece is delivered to a delivery station, such as local post office (41) or private delivery company (42), etc. The said local post office (41) or the private delivery company (42), etc. delivers the said paper mail piece directly to the off-line recipient (2).

When the above-described series of steps for forwarding mail are completed, the sender may have a paper mail piece sent expeditiously to the recipient (2) through a simple e-mail transmission procedure using the Internet.

The central management server (10) has a bilateral connection with branch management servers (20) through a communication network such as the Internet, PSTN (Public Switched Telephone Network), etc. In this state, branch management servers (20) store in the branch management database (31) various information of events occurring in them, such as “quantity of the paper mail supplied in the beginning of the month, estimate delivery period for the paper mail pieces, status of the paper mail delivery, etc.” At the same time, the branch management servers (20) transmit real time the said event information to the central management server (10).

As soon as a branch management server (20) transmits various event information to the central management server (10) in the foregoing manner, the said central management server immediately stores the said event information in the central management database (11). Thus, the central management server (10) may monitor the event status of the branch management servers (20) real time.

Detailed explanation of the method for forwarding hybrid mail using the above-described hybrid mail transmission system will now be provided in the following.

First, a sender, who wishes to send a paper mail piece converted from his or her e-mail, accesses the hybrid mail transmission system of the present invention through the sender side client (1) and the Internet.

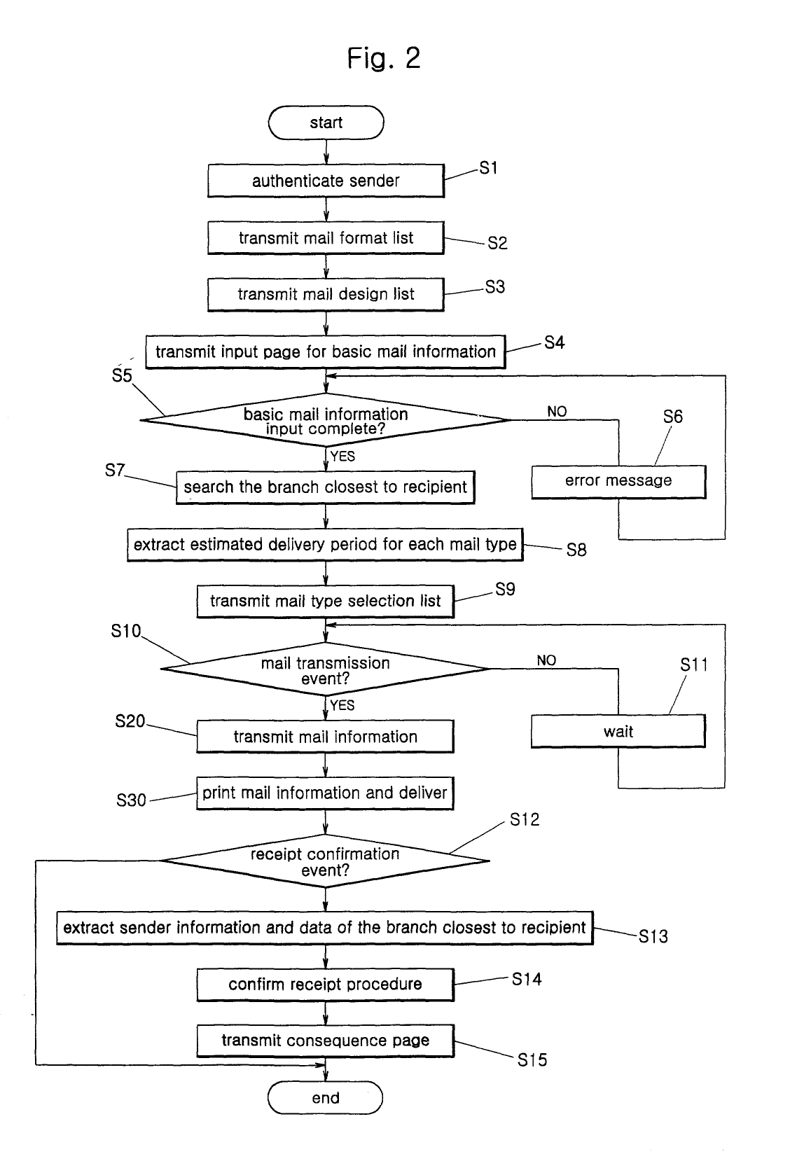

When the sender is connected as described above, the central management server (10) performs the procedure for authentication of the sender's identity as illustrated in FIG. 2 (step S 1).

Here, the central management server (10) extracts from the central management database (11) various information necessary for constructing a web page, creates a page for identity authentication, and transmits expeditiously the completed page for identity authentication to the sender side client (1).

When the page for identity authentication is transmitted from the central management server (10) as described above, the sender side client (1) quickly interprets the said page for identity authentication and displays the interpreted page, enabling the sender to input his or her correct identity information such as the sender's ID, password, etc.

When the sender completes inputting his or her identity information and selects to send the information, the sender side client (1) transmits the completed identity authentication information to the central management server (10).

Once the sender side client (1) transmits the said identity authentication information through the procedure described above, the central management server (1) compares the said transmitted identity authentication information with the data stored in the central management database (11) to determine whether the said sender has the right to use the hybrid mail transmission system of the present invention.

When the sender's identity is authenticated through the steps described above, the central management server (10) extracts various information from the central management database (11), creates a mail format list for “the sender's selection of a format of paper mail,” and transmits the said mail format list to the sender side client (1) (step S2).

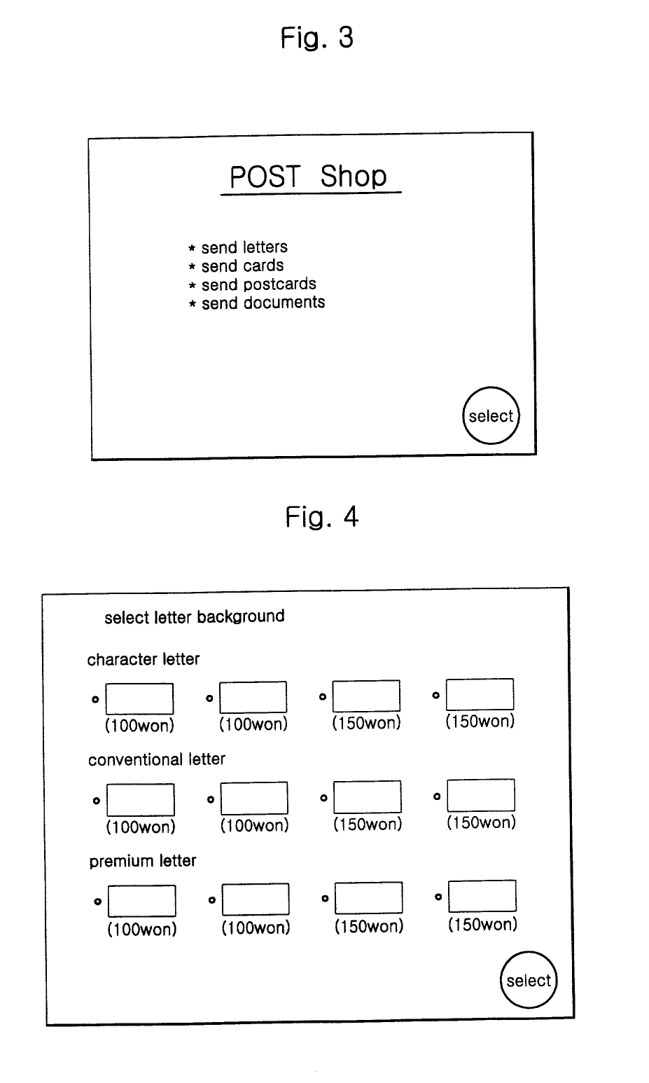

The sender side client (1) quickly interprets the said mail format list transmitted from the central management server (10) and displays the list as illustrated in FIG. 3, so that the sender may select a paper mail format that he or she desires the most.

Once the selection for a paper mail format is completed and the sender chooses to send such selection, the sender side client (1) transmits the completed paper mail format information to the central management server (10).

When the paper mail format information arrives from the sender side client (1) through the procedure described above, the central management server (10) quickly analyzes the said paper mail formation information.

If the sender selects, for example, a letter as the desired paper mail format, the central management server (10) extracts from the central management database (11) various information necessary for creating a web page, creates a mail design list for “the sender's selection of the paper mail design” based upon the said information, and transmits the created mail design list to the sender side client (1) (step S3).

Here, the mail design list transmitted to the sender side client (1) corresponds to the sender's selection of the paper mail format. For example, if the sender selected, for example, a letter as the paper mail format, the mail design list transmitted to the sender side client (1) will be a “letter deign list.”

Once the mail design list is transmitted from the central management server (10) as described above, the sender side client (1) quickly interprets the said mail design list and displays the list as illustrated in FIG. 4, so that the sender may select a design of the paper mail that he or she wishes to use.

When the paper mail design selection is completed and the sender chooses to send the selection, the sender side client (1) transmits the completed paper mail design information to the central management server (10).

Then, the central management server (10) expeditiously analyzes the paper mail design information transmitted from the sender side client (1).

If the sender selects, for example, a character letter, as the paper mail design, the central management server (10) stores such selection first in the central management database (11), so that the sender's paper mail design information may appropriately be reflected in the mail information to be explained in the following.

Then, the central management server (10) extracts from the central management database (11) various information necessary to create a web page, creates a basic mail information page for “the sender's input of basic information related to the paper mail,” and transmits the said basic mail information input page to the sender side client (1) (step S4).

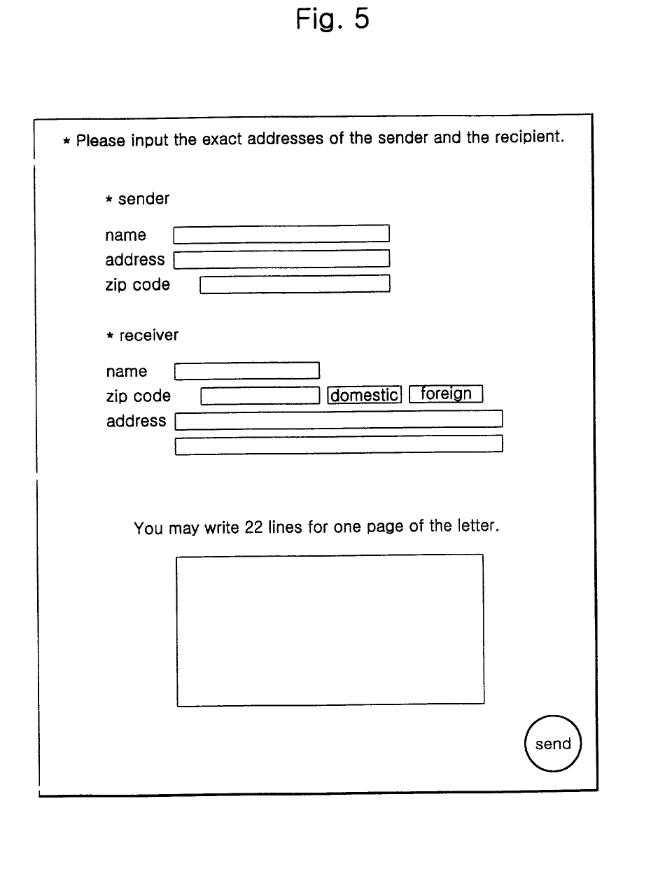

The sender side client (1) quickly interprets the basic mail information input page transmitted from the central management server (10) and displays the page as illustrated in FIG. 5, so that the sender may input basic information regarding the mail, such as the sender's name, address, zip-code, mail contents, etc.

When the input of the basic mail information is completed and the sender chooses to send the said information, the sender side client (1) transmits the completed basic mail information to the central management server (10).

When the said basic mail information is transmitted from the sender side client through the procedure described above, the central management server (10) analyzes the said basic mail information to determine whether all items necessary for the basic mail information have been inputted (step S5).

If not all items necessary for the basic mail information have been inputted (for example, if the sender's address information has not been provided), the central management server (10) moves to step S6 to send to the sender side client an error message such as the one reading “The sender's address has not been provided. Please fill out the sender's address.”

On the other hand, if all items necessary for the basic mail information have been provided, the central management server (10) performs the procedure to search a branch that is closest to the recipient's address based upon the said basic mail information (step S7).

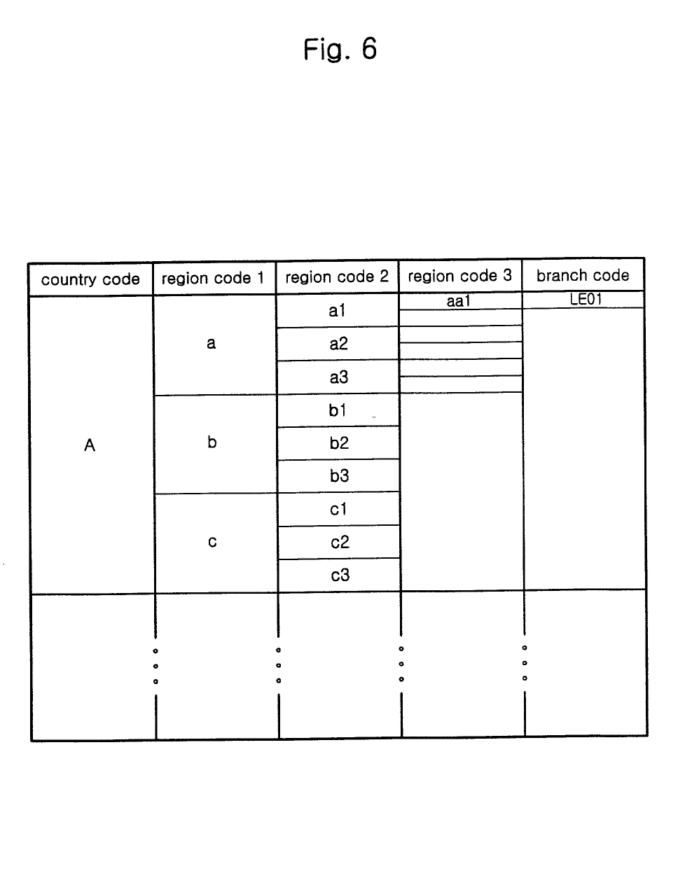

If, for example, the recipient's address in the basic mail information indicates that it is in “A station—a region—a1 region—aa1 region,” the central management server (10), based upon the data table of the central management database (11) as shown in FIG. 6, confirms that the branch with the branch code “LE01” is the branch closest to the recipient's address.

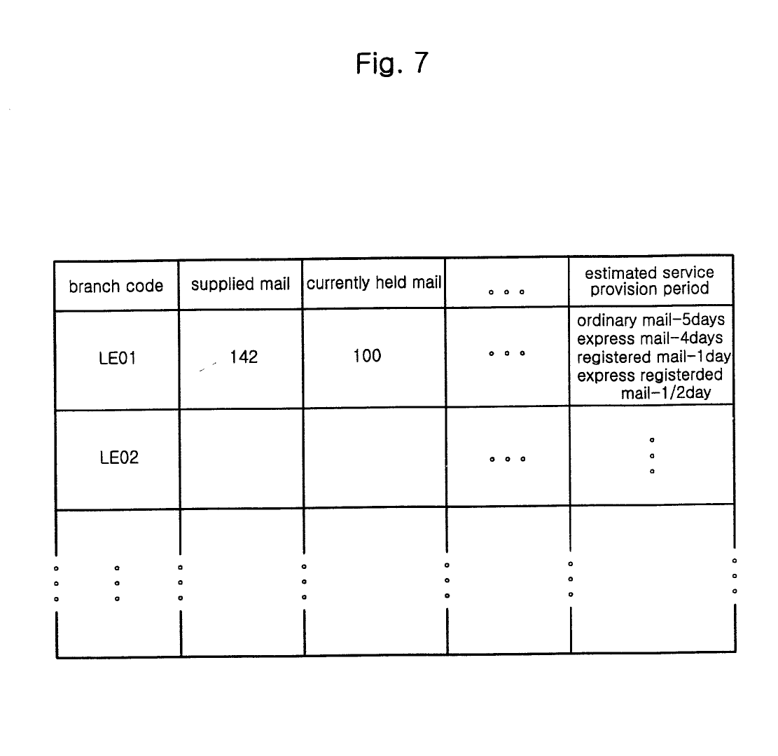

When the branch with the branch code “LE01” is confirmed to be the branch closest to the recipient's address through the procedure described above, the central management server (10), based upon another data table in the central management database (11) as illustrated in FIG. 7, reviews various event information regarding the said branch “LE01,” such as “quantity of the paper mail supplied in the beginning of the month, quantity of the paper mail currently held in the branch, estimate delivery period for the paper mail, etc.” Based upon the said various event information, the central management server (10) obtains the estimate delivery period for each mail type (step SS).

As explained above, because the branch management server (20) (for example, the branch management server (21) of the branch with the branch code “LE01”) transmits its event information to the central management server (10) real time in the bilateral telecommunication environment connecting the central management server (10), the data table of the central management database (11) always contains the latest information, enabling the central management server (10) to monitor the latest information regarding the branch management server (21) of the branch with the branch code “LE01.”

When the central management server (10) extracts the estimate delivery period for each mail type (for example, “ordinary mail—5 days, express mail—4 days, registered mail—1 day, and express registered mail—½ day”), the central management server (10) creates a mail type selection list based upon the said estimate and transmits the said mail type selection list to the sender side client (1) (step S9).

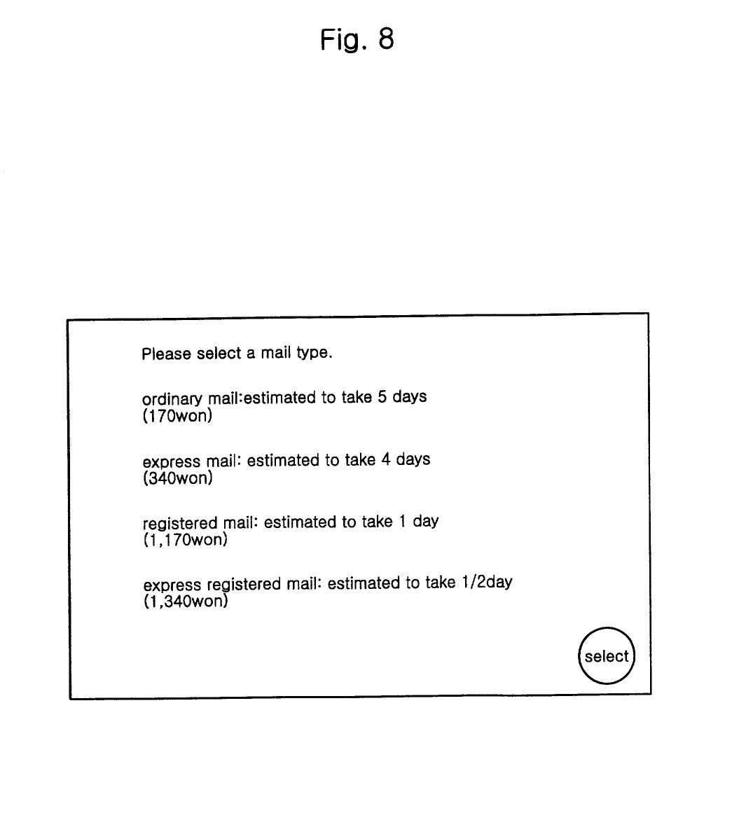

Then, the sender side client (1) interprets the mail type selection list transmitted from the central management server (10) expeditiously and displays the list as illustrated in FIG. 8, so that the sender may select a mail type which is the most appropriate type for him or her among various mail types such as ordinary mail, express mail, registered mail, express registered mail, etc.

When the said mail type selection procedure is completed and the sender chooses to send the selection, the sender side client (1) immediately transmits the completed mail type selection information to the central management server (10).

As illustrated above, through the coordination of the central management server (10) and the branch management servers (20) according to the present invention, the status of the branch closest to the recipient may be recognized real time. Thus, the central management server (10) may easily obtain information such as “when the sender's mail may arrive at the recipient's location” and, as a result, may quickly notify the sender of the estimate delivery period for the paper mail. Consequently, the sender using the present invention may experience a highly improved efficiency in using the hybrid mail system.

When the sender side client (1) transmits the mail type selection information through the steps described above, the central management server (10) determines whether there has been any mail transmission event in the sender side client (1) (step S10).

If there is no mail transmission event from the sender side client (1) because the sender does not choose to send the mail, the central management server (10) goes to step S11—waiting state.

In contrast, if there occurs a mail transmission event from the sender side client (1) because the sender chooses to send the mail, the central management server (10) immediately proceeds to transmit mail information to the branch management server (21) of the above-described closest branch, for example, the branch with the branch code “LE01” (step S20).

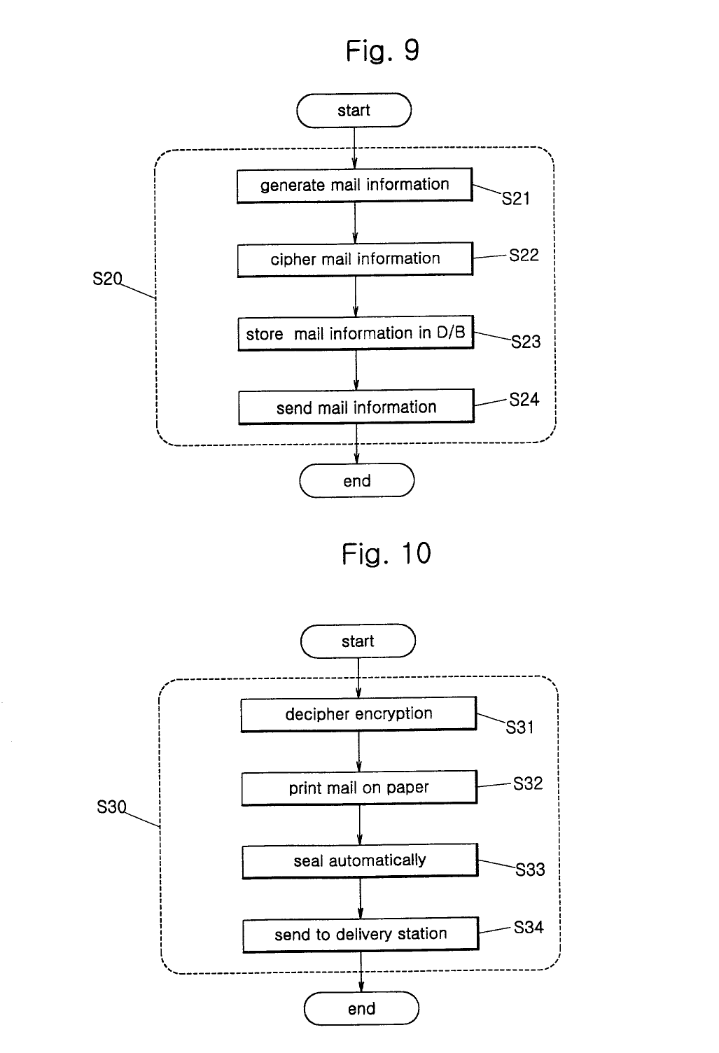

In this case, the central management server (10) first creates mail information reflecting the above-described various information such as the mail format information, mail design information, basic mail information, and mail type selection information, etc., as illustrated in FIG. 9 (step S21).

Then, the central management server (10) ciphers the mail information created in the above-described step (step S22).

Such ciphered mail information may be deciphered only through a specific program provided by the central management server (10). The central management server (10) will have previously distributed such specific program to each branch management server (20), so that such branch management server (20) may easily decode the mail information immediately upon receiving such mail information.

After step S22, the central management server (10) stores the ciphered mail information in the central management database (11) (step S23).

Because mail information is stored in the central management database (11) as described above, the central management server (10) may immediately restore the mail information even when the sender's mail information transmitted to the branch management server (20) is lost for any unexpected accident. Furthermore, the mail information stored in the central management database (11) may be processed in various ways to create new data such as recipient address list and mail list information, etc. Thus, a sender may take advantage of various other services conveniently in addition to mail transmission service.

When the steps for storing mail information in database are completed, the central management server (10) transmits, through a communication network such as the Internet or PSTN, the ciphered mail information to the branch management server (21) of the branch closest to the recipient's address, for example, to the branch with the branch code “LE01” (step S24).

When the ciphered mail information arrives at the branch management server (21) of the branch with the branch code “LE01” through the step described above, the said branch management server (21) converts the transmitted mail information into a paper mail piece and proceeds to steps to deliver such paper mail to the recipient's address (step S30).

For the above-mentioned procedure, as illustrated in FIG. 10, the branch management server (21), first, decodes the mail information ciphered by the central management server (10) (step S31). As explained above, the branch management server (21) has already installed in it a specific program to conveniently decode the ciphered mail information and, thus, may exactly restore the mail information transmitted from the central management server (10).

Thereafter, the branch management server (21) prints out the decoded mail information to create a paper mail piece and seal such printed paper mail piece (steps S32 and S33). For these procedures, the branch management server (21) must have been equipped with a printer to print various formats of e-mail into paper mail pieces and a automatic sealer to securely seal the outputted paper mail pieces. In this manner, the above-described procedures of paper mail printing and paper mail sealing may be performed expeditiously without difficulties.

Then, the operator company of the branch management server (21) delivers the sealed paper mail to a delivery station such as a local post office (41) so that the paper mail may be safely delivered off-line to the recipient (2) (step S34).

When all of these mail forwarding steps are performed, the sender, merely through a simple e-mail transmission on the Internet, may send a paper mail piece easily and quickly to the recipient (2).

After step S20, the central management server (10) performs a process to determine whether there has been any receipt confirmation event from the sender side client (1) as illustrated in the above-mentioned FIG. 2 (step S12).

If there is no receipt confirmation event from the sender side client (1) because the sender does not choose to confirm the receipt of the transmitted paper mail, the central management server (10) terminates the process flow.

In contrast, if there is a receipt confirmation event from the sender side client (1) because the sender chooses to confirm the receipt of the transmitted paper mail, the central management server (10) extracts the basic mail information stored in the central management database (11), selects the closest branch corresponding to the sender information, and extracts real time the status of such closest branch (step S13).

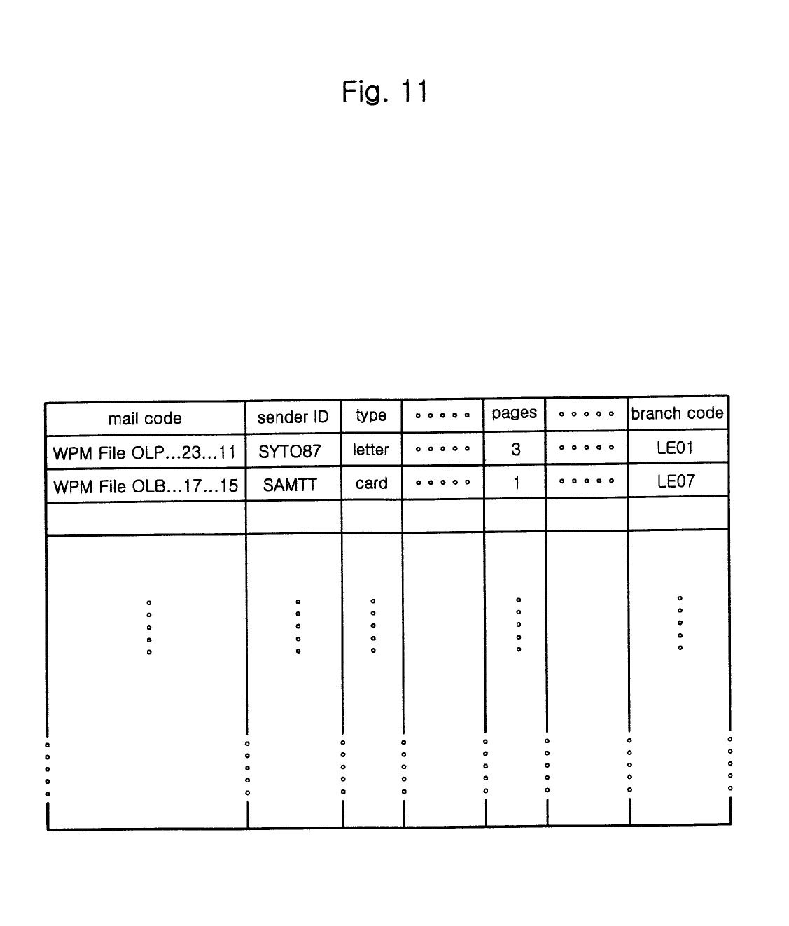

Then, the central management server (10) confirms various sender information such as “the sender's mail code, sender ID, mail type, branch code, etc.” based upon such data table from the central management database as illustrated in FIG. 11, and, from such information, extracts the branch code, for example, “LE01.”

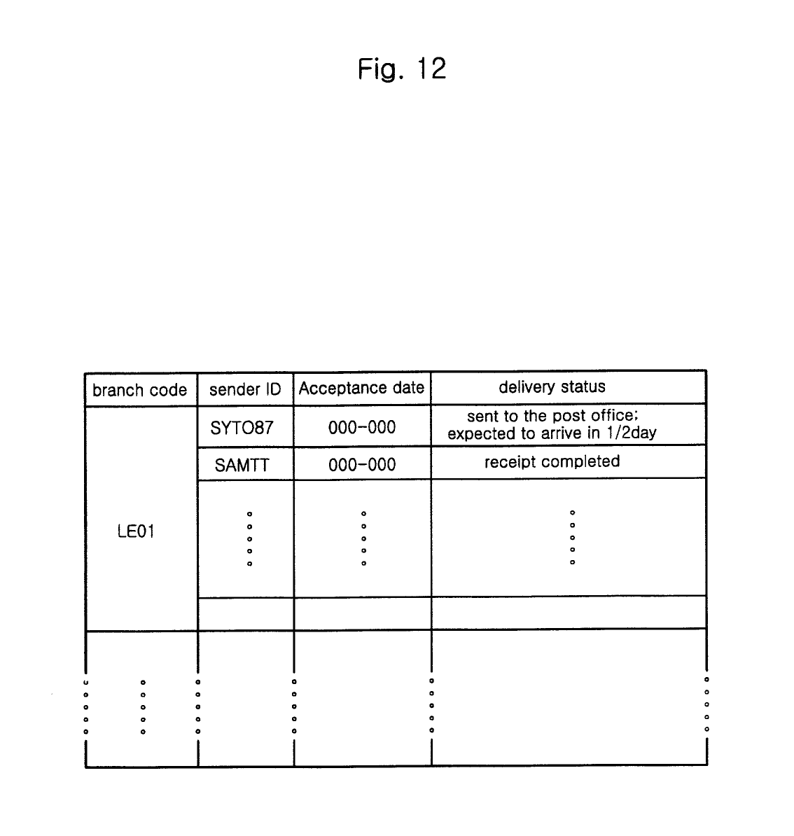

The central management server (10) then proceeds to search, based upon the said branch code, other data tables of the central management database as illustrated in FIG. 12, and extracts various branch status information such as the sender ID, acceptance date, delivery status, etc.

When the information on the closest branch status is extracted, the central management server (1), based upon such status information, confirms the receipt of the paper mail and creates a receipt confirmation consequence page reflecting the results of the receipt confirmation. As soon as such consequence page is completed, the central management server (10) transmits the said page to the sender side client (1) (steps S14 and S15).

For instance, if the sender who requested receipt confirmation for a paper mail piece has the sender ID “SAMTT,” the central management server (10), as illustrated in the drawing, confirms that the paper mail piece was received by the recipient and expeditiously transmits to the sender side client (1) a receipt confirmation consequence page containing such result of receipt completion.

If a receipt confirmation consequence data is transmitted from the central management server (10) as described above, the sender side client (1) quickly interprets and displays such data so that the sender may immediately confirm that, for example, “the mail sent by the sender with the sender ID SAMTT has been securely delivered to the recipient.”

As explained above, through the coordination of the central management server (10) and the branch management servers (20) according to the present invention, the status of the closest branch may be recognized real time and, thus, the central management server (10) may easily obtain information such as “the current delivery status for paper mail.” Resultantly, the central management server may expeditiously notify the sender of the receipt status of paper mail. Therefore, a sender using the present invention, may experience a greatly improved efficiency of the hybrid mail system.

Furthermore, whenever there is a mail transmission event issued by a sender, the central management server (10), through coordination with the said branch management servers (20), notifies, real time, the sender of information such as the estimate delivery period for the paper mail, receipt status of the paper mail, etc., maximizing the efficiency in the sender's use of the hybrid mail system.

Even though a specific embodiment of the present invention has been explained and illustrated in the foregoing, the present invention may of course be modified in various ways and embodied accordingly by persons in the art.

Any of such modified embodiments shall not be understood separately from the technical concept or viewpoint of the present invention and such modified embodiments must be deemed included in the following claims.

What is claimed is:

1. A method for forwarding hybrid mail comprising the steps of:
transmitting a page for basic mail information input to a sender side client;
determining whether the basic mail information input procedure using the said transmitted page for the basic mail information input has been completed;
if the said basic mail information input procedure has been completed, searching for a branch which is closest to the recipient's address based upon the said basic mail information;
calculating the estimate delivery period for a paper mail piece by extracting real time the current status of the said closest branch;
transmitting to the sender side client the message containing the estimate delivery period for the paper mail piece;
determining whether a mail transmission event has occurred from the said sender side client;
if a mail transmission event has occurred from the said sender side client, transmitting to the said closest branch the mail information prepared based upon the said basic mail information; and
converting the said mail information into a paper mail piece and delivering the said paper mail piece to the said recipient's address.

2. The method for forwarding hybrid mail according to claim 1, wherein a message containing the said estimate delivery period for the said paper mail piece is combined with the mail type selection list and transmitted to the said sender side client.

3. The method for forwarding hybrid mail according to claim 1, further comprising the steps of:
determining whether a receipt confirmation event to confirm the receipt of the said paper mail has been occurred from the said sender side client, after the step of transmitting the said mail information to the said closest branch;
if a receipt confirmation event has occurred from the said sender side client, extracting sender information from the basic mail information while selecting the closest branch corresponding to the sender information and extracting real time the selected closest branch's status;
confirming the receipt of the said paper mail piece based upon the said closest branch's status; and
creating a receipt confirmation consequence page containing the result of the receipt confirmation for the said paper mail piece and then transmitting the said receipt confirmation consequence data to the said sender side client.

4. The method for forwarding hybrid mail according to claim 1, wherein the said step of transmitting the said mail information to the said closest branch comprises the steps of:
creating the said mail information based upon the said basic mail information;
ciphering the said mail information;
storing the said ciphered mail information into a database; and
transmitting the said ciphered mail information to the closest branch determined by the said basic mail information.

5. The method for forwarding hybrid mail according to claim 1, wherein the said step of converting the said mail information into the said paper mail piece and delivering the said paper mail piece to the said recipient's address comprises the steps of:
decoding ciphered said mail information;
printing out the said mail information into a paper mail piece;
sealing the said paper mail piece; and
forwarding the said sealed paper mail piece into a delivery station and delivering the said paper mail piece to the said recipient's address.

6. The method for forwarding hybrid mail according to claim 1, further comprising the step of authenticating the identity of the sender manipulating the said sender side client, prior to the said step of transmitting the input page for the basic mail information to the said sender side client.

7. The method for forwarding hybrid mail according to claim 1, further comprising the step of transmitting to the said sender side client a mail format list for designation of a format for the said paper mail piece, prior to the said step of transmitting the input page for the basic mail information to the said sender side client.

8. The method for forwarding hybrid mail according to claim 1, further comprising the step of transmitting to the said sender side client a mail design list for designation of a design for the said paper mail piece, prior to the said step of transmitting the input page for the basic mail information to the said sender side client.
